(19) United States
(12) Patent Application Publication
(10) Pub. No.: US 2011/0286443 A1
(43) Pub. Date: Nov. 24, 2011

(54) SYSTEM, APPARATUS AND METHOD FOR ROAMING IN DECT-VOIP NETWORK

(75) Inventors: Chi-Kai Jerome Wu, Taipei (TW); Yuh Tsang Chuang, Hsinchu (TW)

(73) Assignees: NATIONAL DATACOMM CORPORATION, Hsinchu (TW); Chi-Kai Jerome Wu, Taipei City (TW)

(21) Appl. No.: 12/783,704

(22) Filed: May 20, 2010

(51) Int. Cl. H04L 12/66; H04B 7/00; H04W 4/00

(52) U.S. Cl. 370/352; 370/310; 455/432.1

(57) ABSTRACT

A system, an apparatus and related method for roaming in DECT-VoIP network are provided. The system for roaming in DECT-VoIP network includes at least a DECT-VoIP handset, and at least a DECT-VoIP apparatus. The system can be connected to the Internet through connecting the DECT-VoIP apparatus to appropriate internet access device, such as, ADSL modem or IP PBX so as to make and receive phone calls through VoIP. With presetting the VoIP client account information at the DECT-VoIP handset, the DECT-VoIP handset can roam from the coverage of a first DECT-VoIP apparatus previously registered with to the coverage of a second DECT-VoIP apparatus sharing the same ID with the first DECT-VoIP apparatus without interruption to the connection.

### FIELD OF THE INVENTION

The present invention generally relates to a system, apparatus and method for roaming in DECT-VoIP network.

### BACKGROUND OF THE INVENTION

The Digital Enhanced Cordless Telecommunications (DECT) standard provides a general radio access technology before the arrival of cellular phones. A DECT system usually comprises a DECT fixed part having at least one base station, and at least one DECT portable part, i.e., cordless DECT handset. In principle, the DECT standard only covers the “air interface” between a DECT fixed part and a DECT portable part. The DECT standard defines application profiles for containing additional specifications of how the DECT air interface should be used in specific applications. For example, the Generic Access Profile (GAP) is the basic profile defining a minimum mandatory set of requirements to ensure interoperability. The GAP is the basis for all other DECT speech profiles. FIG. 1 shows a schematic view of a DECT system. As shown in FIG. 1, a DECT handset is linked to a DECT base via the “air interface”, i.e., radio link, to connect to the external network, such as, PSTN, and so on.

A DECT base is continuously transmitting on at least a channel so as to provide a beacon function for DECT handsets to lock-on to. The handsets locked-on to a beacon transmission will analyze the broadcast information from the beacon to find out whether the DECT handset has access rights to the system to set up a communication link.

Due to the security, DECT bases have a built-in protocol to prevent DECT handsets without pre-registration with the DECT base from accessing the DECT base. Under this circumstance, a DECT handset can only communicate with this specific DECT base that the DECT handset has pre-registered. In other words, DECT handsets do not have the full mobility, like cellular phone, to roam across network wherever there is radio signal coverage.

While the DECT is an access technology and network-wide mobility is outside of the scope of the standard, additional application profiles are defined to extend the mobile capability by interfacing other communication networks, for example, DECT/GSM Interworking Profile (GIP), ISDN Interworking Profiles (IAP and IIP). On the other hand, the Cordless Terminal Mobility (CTM) Access Profiles (CAP) defines the CTM service to allow cordless terminals to roam within and between networks, wherever radio coverage is provided and the cordless terminal has the appropriate access rights. The CAP is similar to the DECT-GSM interworking with the difference that CAP is not limited to the mobility functions of existing GSM network. The CAP protocol provides the mobility via traditional circuit switch architect. The CAP aims at maintaining compatibility with GAP. However, the complexity makes the devices with DECT CAP protocol expensive and thus a less attractive alternative in the market.

At present, the rapid development of VoIP makes the DECT-VoIP application popular and many DECT-VoIP (based on GAP protocol) handsets are currently available in the market, mostly used for the home or office application. FIG. 2 shows a schematic view of a conventional configuration of a DECT-VoIP system. As shown in FIG. 2, a DECT-VoIP system includes at least a DECT base integrated with a VoIP gateway, and at least a DECT handset. The system is then connected to the Internet through appropriate Internet access device and link, such as, ADSL modem via ADSL line, or IP PBX. It's worth noting that, with the aforementioned configuration, the VoIP gateway must be preset with VoIP client accounts. In this manner, the DECT handset can make a VoIP phone call via the preset VoIP client account stored in the integrated DECT base. However, this architecture restricts the DECT handset's mobility as the DECT handset can only make VoIP phone call through this specific DECT-VoIP base and via the fixed communication link connected to the VoIP gateway.

As the VoIP technology is innately capable for user roaming, the above restriction mainly comes from the two factors. First, the security of DECT GAP protocol requires a cipher key to be generated to prevent the communication from being hijacked. A new cipher key is generated each time when a DECT handset is placed on the cradle of the DECT base or when the user presses the registration button on DECT handset and DECT base simultaneously. The cipher key is only known to the DECT handset and the DECT base. In addition, the DECT handset cannot connect to another DECT base without knowing the cipher key to that DECT base. The second restrictive factor comes from that the VoIP account is registered at the integrated DECT-VoIP gateway side with ADSL as the broadband to the Internet. As the VoIP account is not stored on the DECT handset, the DECT handset cannot connect to another integrated DECT-VoIP gateway as that DECT-VoIP gateway does not have the VoIP account corresponding to the DECT handset

As the DECT technology has competitive advantages regarding various criteria, such as, spectrum efficiency and reliable radio access, and in many applications, such as, cost effective in business setting, it is imperative to devise a solution to enable roaming mobility of the current DECT-VoIP to make the DECT technology an even more attractive alternative.

### SUMMARY OF THE INVENTION

The present invention has been made to overcome the above-mentioned drawback of conventional DECT-VoIP system. The primary object of the present invention is to provide a system, apparatus and method for roaming in DECT-VoIP network.

An exemplary embodiment of the present invention provides a system for roaming in DECT-VoIP network. The system includes a DECT-VoIP handset, and a DECT-VoIP apparatus. The system can be connected to the Internet through connecting the DECT-VoIP apparatus to appropriate internet access device, such as, ADSL modem or IP PBX so as to make and receive phone calls through VoIP. With presetting the VoIP client account information at the DECT-VoIP handset, the DECT-VoIP handset can roam from the coverage of a first DECT-VoIP apparatus previously registered with to the coverage of a second DECT-VoIP apparatus sharing the same DECT base ID with the first DECT-VoIP apparatus without interruption to the connection.

Another exemplary embodiment of the present invention provides an apparatus for roaming in DECT-VoIP network. The apparatus includes a DECT base module, a voice processing module and a session initiation protocol (SIP) user agent (UA) module. The SIP UA module is connected to, for example, the IP PBX to act as a user agent. The DECT base module is for connecting to DECT handset via radio link, as in the conventional DECT base. The voice processing module is connected to the DECT base module for voice processing, or converting the pre-stored VoIP client account entered by the user via a touch tone keypad of VoIP-DECT handset. The SIP UA module is connected to voice processing module, and acts as the VoIP gateway to the Internet access device for connecting to VoIP server, as well as connecting to IP PBX for account query if necessary.

Yet another exemplary embodiment of the present invention provides a method for roaming in DECT-VoIP network, including the steps of: DECT-VoIP handset registering to VoIP server; DECT-VoIP handset roaming to another DECT-VoIP apparatus and requesting a new registration to the VoIP server; VoIP server paging both DECT-VoIP apparatuses to determine whether the roaming being normal; if normal, de-registering the old registration and registering the new registration to achieve roaming; otherwise, notifying both apparatuses the occurrence of an account duplicate situation.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional DECT system;

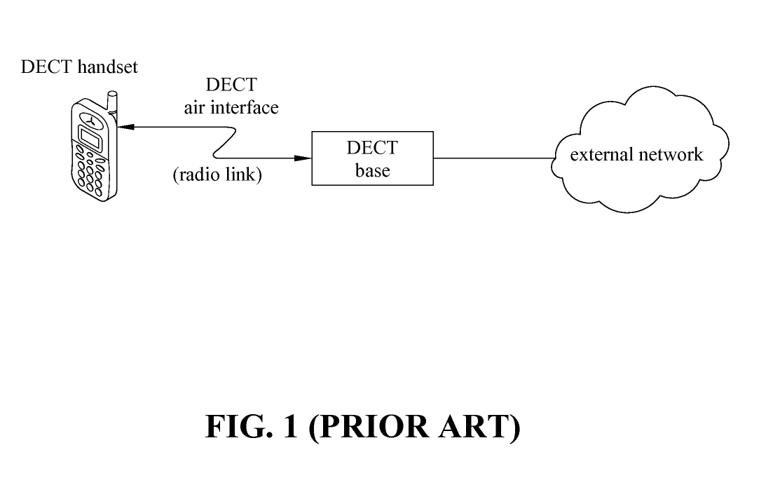

FIG. 2 shows a schematic view of a conventional DECT-VoIP system;

FIG. 3 shows a schematic view of a DECT-VoIP system for roaming in DECT-VoIP network according to the present invention;

FIG. 4 shows a schematic view of another embodiment of a DECT-VoIP system for roaming in DECT-VoIP network according to the present invention;

FIG. 5 shows a schematic view of a DECT-VoIP apparatus for roaming in DECT-VoIP network according to the present invention;

FIG. 6 shows a flowchart of the method for roaming in DECT-VoIP network according to the present invention;

FIG. 7 shows a schematic view of signaling during the registration process in the DECT-VoIP system according to the present invention;

FIG. 8 shows a schematic view of signaling during the normal roaming process in the DECT-VoIP system according to the present invention;

FIG. 9 shows a schematic view of the signaling during an account duplicate situation in the DECT-VoIP system according to the present invention; and

FIG. 10 shows a schematic view of a handset table maintained by DECT-VoIP apparatus according to the present invention.

### DETAILED DESCRIPTION OF THE PREFERRED EMBODIMENTS

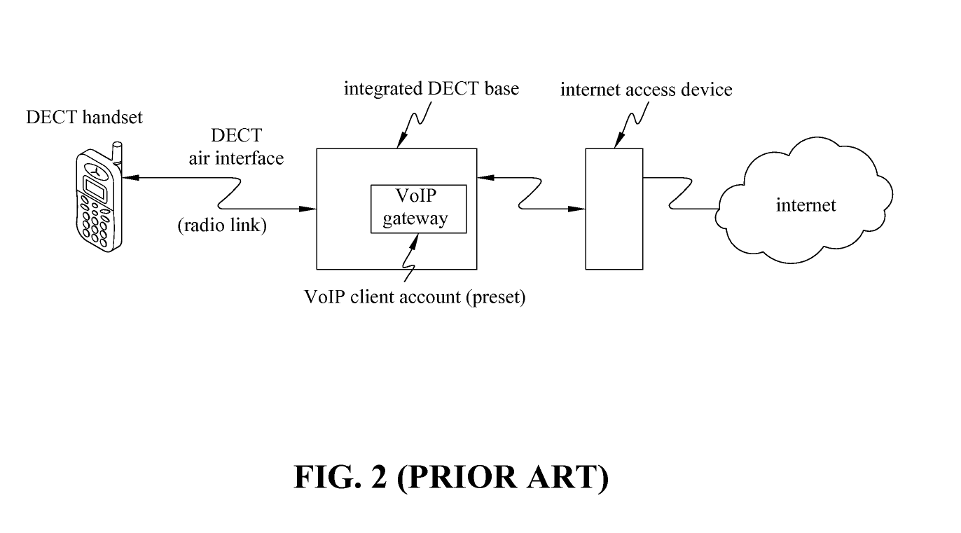

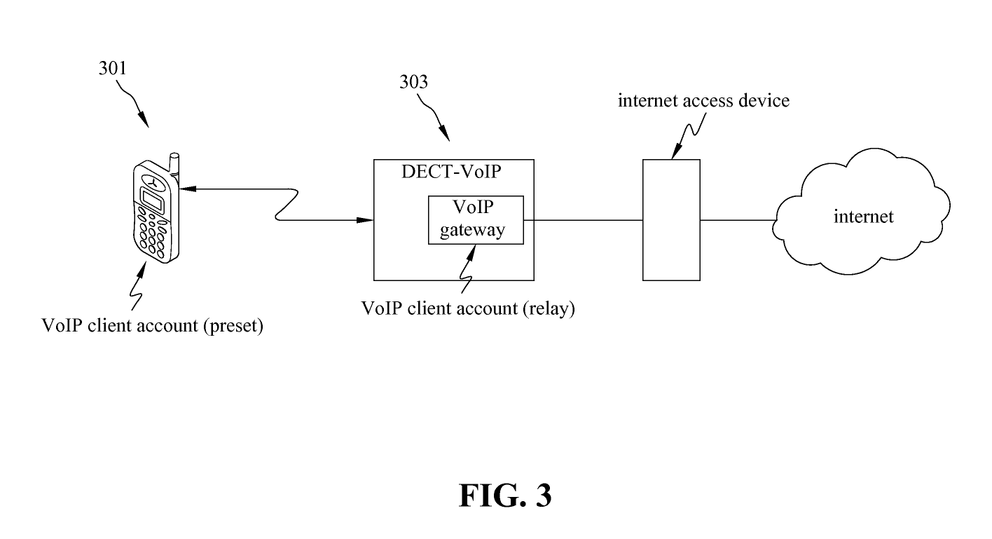

FIG. 3 shows a schematic view of a system for roaming in DECT-VoIP network according to the present invention. As shown in FIG. 3, a system for roaming in DECT-VoIP network includes a DECT-VoIP handset 301 and a DECT-VoIP apparatus 303. DECT-VoIP handset is a DECT handset with preset VoIP client account. DECT-VoIP apparatus 303 is a DECT base station integrated with a VoIP gateway able to relay VoIP client account. DECT-VoIP handset 301 can be connected to DECT-VoIP apparatus 303 via radio link, i.e., the air interface defined in the GAP profile of DECT standard, and DECT-VoIP apparatus 303 is connected to the Internet via ADSL modem or IP PBX. Compared to FIG. 2, the system in FIG. 3 has a similar configuration except that, in FIG. 3, the preset VoIP client account information is stored on DECT-VoIP handset 301 and DECT-VoIP apparatus 303 is only to relay the preset VoIP client account information from DECT-VoIP handset 301 to the IP PBX when connecting for calls, while in FIG. 2, the preset VoIP client account information is stored on the integrated DECT-VoIP base. With the preset VoIP client account information stored on DECT-VoIP handset 301, when DECT handset 301 makes a VoIP call, DECT-VoIP handset 301 will pass the own pre-stored VoIP client account information to DECT-VoIP apparatus 303, and DECT-VoIP apparatus 303 will act as an agent to use this VoIP client account information sent by DECT-VoIP handset 301 to authenticate this account with VoIP server (not shown) for the registration. Once the authentication is through, the VoIP call can be made by DECT-VoIP handset 301. In actual realization, DECT-VoIP handset 301 can further include a memory to store the VoIP client account information.

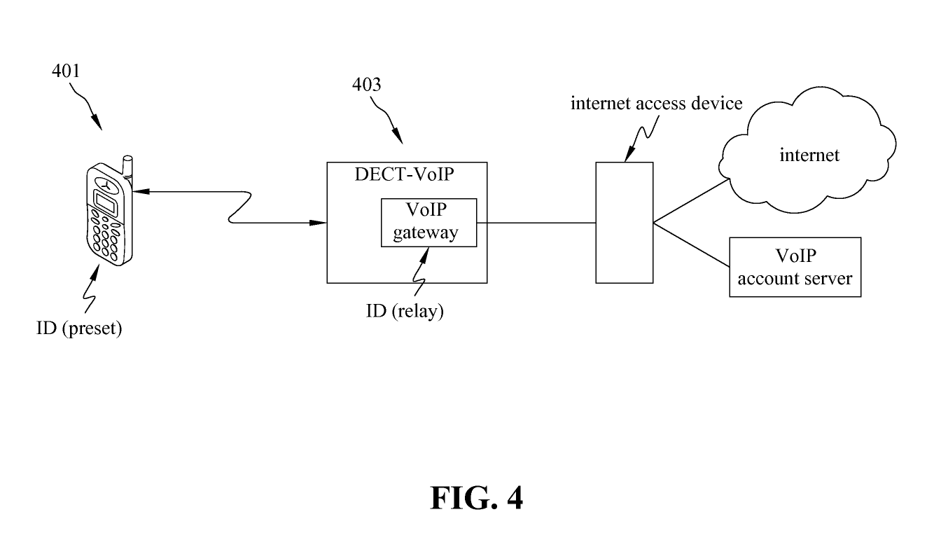

FIG. 4 shows a schematic view of another embodiment of the system for roaming in DECT-VoIP network according to the present invention. The embodiment of FIG. 4 is similar to the embodiment of FIG. 3, except that DECT-VoIP handset 401 is preset to store a handset ID instead of VoIP client account information as in FIG. 3. Thus, DECT-VoIP apparatus 403 only needs to relay the handset ID information, instead of the complete VoIP client account information for authentication. However, with only the handset ID information stored at DECT-VoIP handset 401, DECT-VoIP apparatus 403 must use the handset ID to query the VoIP client account information from a VoIP account server. The VoIP account server may include a database to map the handset ID to a VoIP client account. Once the VoIP client account information is obtained, DECT-VoIP apparatus will use this VoIP client account information to register to the VoIP server to complete the connection and make the VoIP calls. The advantage of this embodiment is that the VoIP client accounts are managed by the VoIP account server and the user does not need to enter any client account information when making calls. In actual realization, the VoIP account server and VoIP serve can reside on the same host. The handset ID can be implemented in various ways, for example, by using a SIM card.

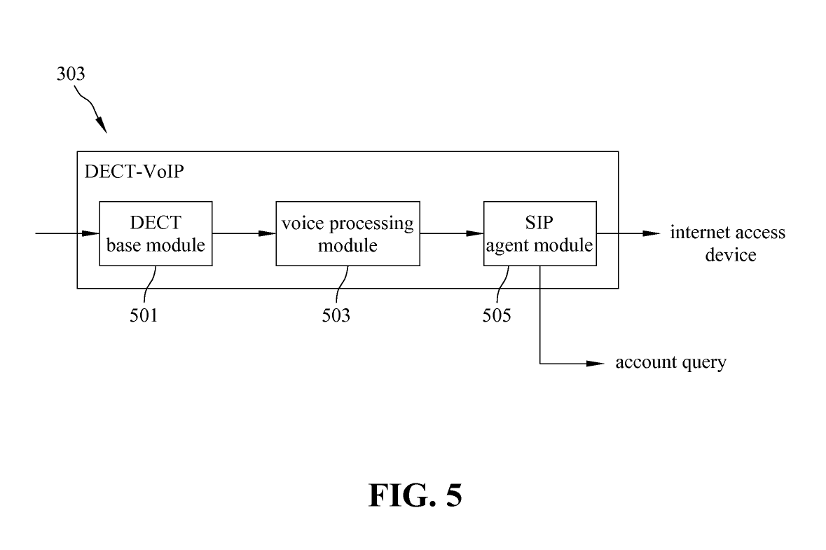

FIG. 5 shows a schematic view of the DECT-VoIP apparatus for roaming in DECT-VoIP network according to the present invention. As shown in FIG. 5, a DECT-VoIP apparatus 303 includes a DECT base module 501, a voice processing module 503, and an SIP user agent (UA) module 505. DECT base module 501 is for connecting to DECT handset via radio link, as in the conventional DECT base. Voice processing module 503 is connected to DECT base module 501 for voice processing, or converting the pre-stored VoIP client account entered by the user via a touch tone keypad of VoIP-DECT handset. SIP UA module 505 is connected to voice processing module 503, and acts as the VoIP gateway to the Internet access device for connecting to VoIP server, as well as connecting to IP PBX for account query if necessary.

In order to achieve roaming, the present invention must overcome the restriction of the conventional DECT protocol that a cipher key generated based on the unique DECT handset ID and DECT base ID and stored on the DECT handset as an authentication key between a DECT handset and a previous registered DECT base. To overcome the above restriction, the DECT-VoIP apparatus of the present invention allows a DECT-VoIP handset to connect to every DECT-VoIP apparatus of the present invention wherever the radio signal can reach. By letting every DECT-VoIP apparatus of the present invention have the same DECT Base ID and each DECT-VoIP handset keep its own unique ID, the cipher key can be self generated by DECT-VoIP handset's program via the known parameters, such as, the DECT-VoIP handset's own handset ID, a pre-defined number emulating the random number generation defined by DECT GAP protocol, and the identical DECT base's ID to comply with GAP protocol. Under this pre-setup, DECT-VoIP handset will automatically register with DECT-VoIP apparatus with the known DECT base ID as long as the radio coverage does exist. In fact, DECT-VoIP apparatus will ignore the key authentication defined by GAP protocol and allow the temporary registration of the DECT-VoIP handset. The authentication will be executed at VoIP account stage instead of the cipher key defined by DECT GAP protocol. Once the VoIP account of the DECT-VoIP handset is authenticated, DECT-VoIP apparatus will grant the registration of DECT-VoIP handset. Otherwise; the DECT-VoIP handset's temporary registration at DECT-VoIP apparatus will be deleted. With this design, the system of the present invention allows the DECT-VoIP handset to roam among the coverage of the DECT-VoIP apparatuses having the same DECT Base ID, i.e., resembling the situation that the DECT-VoIP handset has pre-registered with the DECT-VoIP apparatus.

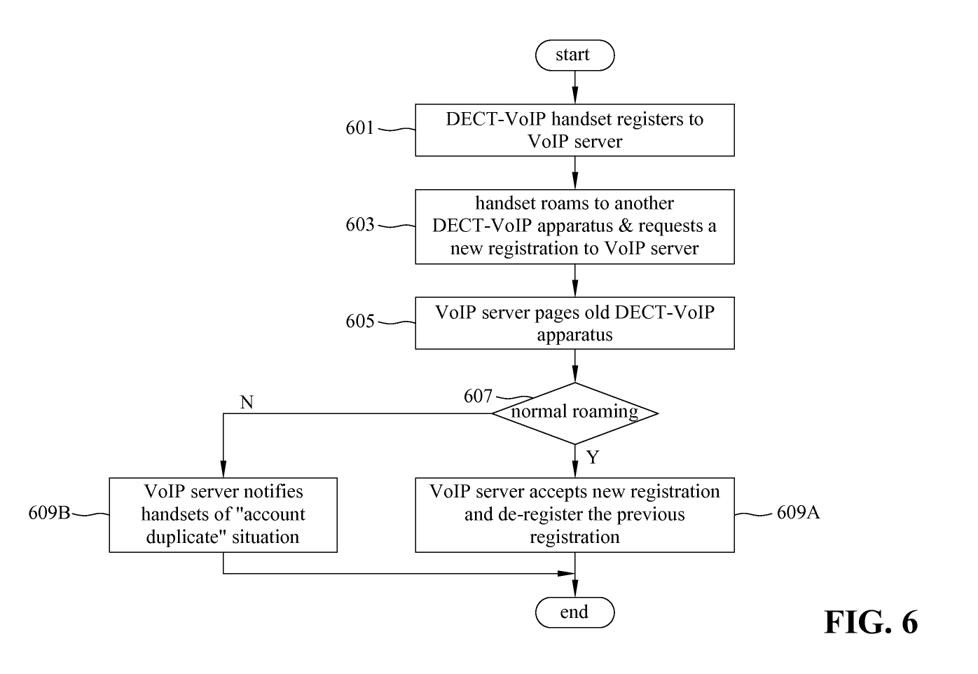

FIG. 6 shows a flowchart of the method for roaming in DECT-VoIP network according to the present invention. As shown in FIG. 6, step 601 is for the DECT-VoIP handset to register to VoIP server. In step 603, when a DECT-VoIP handset roams to the coverage area of another DECT-VoIP apparatus, DECT-VoIP handset requests to the VoIP server for a new registration. In Step 605, upon receiving the new registration request, the VoIP server will page the previous DECT-VoIP apparatus to find out whether the DECT-VoIP handset is still present at the VoIP client of the previously registered DECT-VoIP apparatus. It is worth noting that this paging command is a background paging between the DECT-VoIP apparatus and the DECT-VoIP handset without activating the handset's ringer. Step 607 is to determine whether the roaming of the DECT-VoIP handset is a normal roaming by the response of the above background paging command. If the DECT-VoIP handset cannot be paged at the previous registered DECT-VoIP apparatus, the DECT-VoIP handset is determined to have roamed to a new location and wants to connect to VoIP server for a new registration, as shown in step 609A. In other words, a normal roaming has occurred and the VoIP server will accept this new registration and notify the previously registered DECT-VoIP apparatus to de-register this DECT-VoIP handset. On the other hand, if the DECT-VoIP can be paged at the previously registered DECT-VoIP apparatus, an “account duplicate” situation has occurred, and both the previously registered DECT-VoIP apparatus and the new DECT-VoIP apparatus are notified, as shown in step 609B. The “account duplicate” situation implies that two different DECT-VoIP handsets have the same ID (i.e., VoIP client account) try to connect to two different DECT-VoIP apparatuses at different locations. In this situation, an “account duplicate” message will be displayed on both the DECT-VoIP handsets to notify the users so that the legitimate user will be ware of the situation.

It is worth noting that the above process of handling DECT-VoIP handset roaming can detect the existence of duplicated DECT-VoIP handset so as to prevent the account being hijacked during the roaming process.

Furthermore, to enable the VoIP server to perform the background paging command to determine the normalcy of the roaming, an account query agent (AQA) software module is added to the VoIP server to act as an agent to pass the request from SIP user agent module to VoIP account server and forward the VoIP account server's response back to SIP user agent module. The following describes the signaling details between different entities during the registration process and the roaming process.

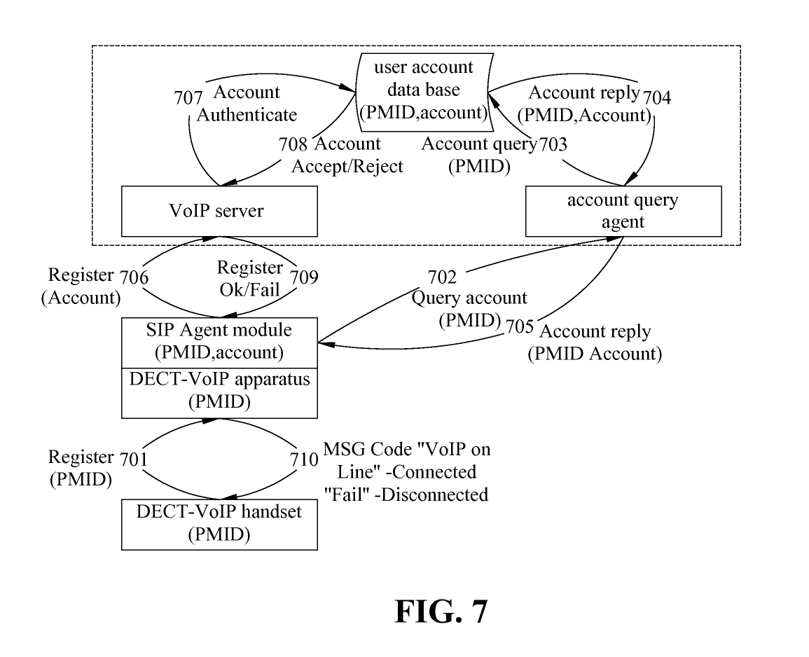

FIG. 7 shows a schematic view of the DECT-VoIP signaling between the DECT-VoIP handset, the DECT-VoIP apparatus (DECT base module and SIP user agent module) and VoIP account server (AQA module and account database) during the registration process according to the present invention. As shown in FIG. 7, for registration, DECT-VoIP handset sends a registration request, marked as 701, with the PMID as parameter to the DECT base module of DECT-VoIP apparatus. The PMID registration request is passed by the SIP user agent module of DECT-VoIP apparatus to AQA module for account query (marked as 702) and is then relayed by AQA module to account database (marked as 703). The account database sends the account query result back to AQA module (marked as 704), which is forwarded to the SIP user agent module of DECT-apparatus, marked as 705. SIP user agent module sends a registration request, marked as 706, with the account as parameter to the VoIP server. VoIP server consults user database for authentication of the account of registration request (marked as 707). The account database responds to the request (either accept or reject) and sends the response to VoIP server, marked as 708. The result of registration request (Ok or fail) is transmitted to SIP user agent module, marked as 709, and then back to DECT-VoIP handset, marked as 710, for connection or disconnection.

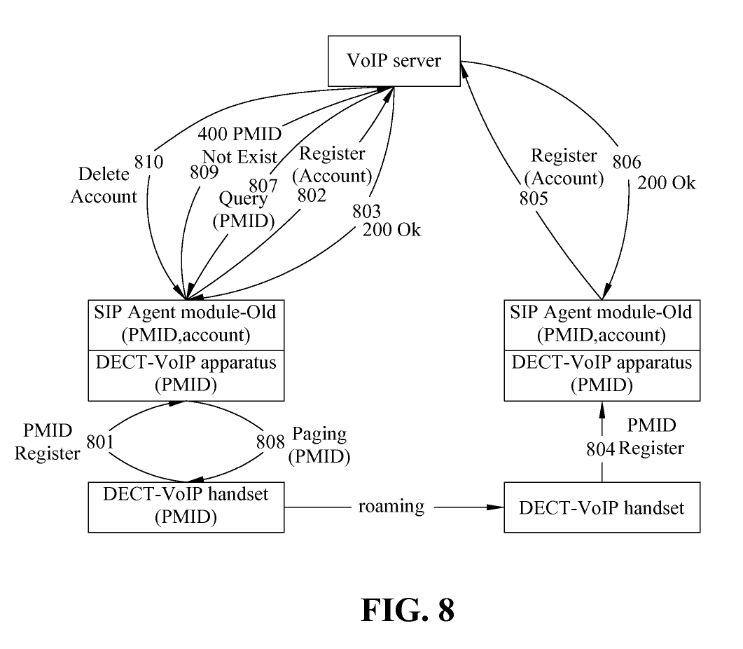

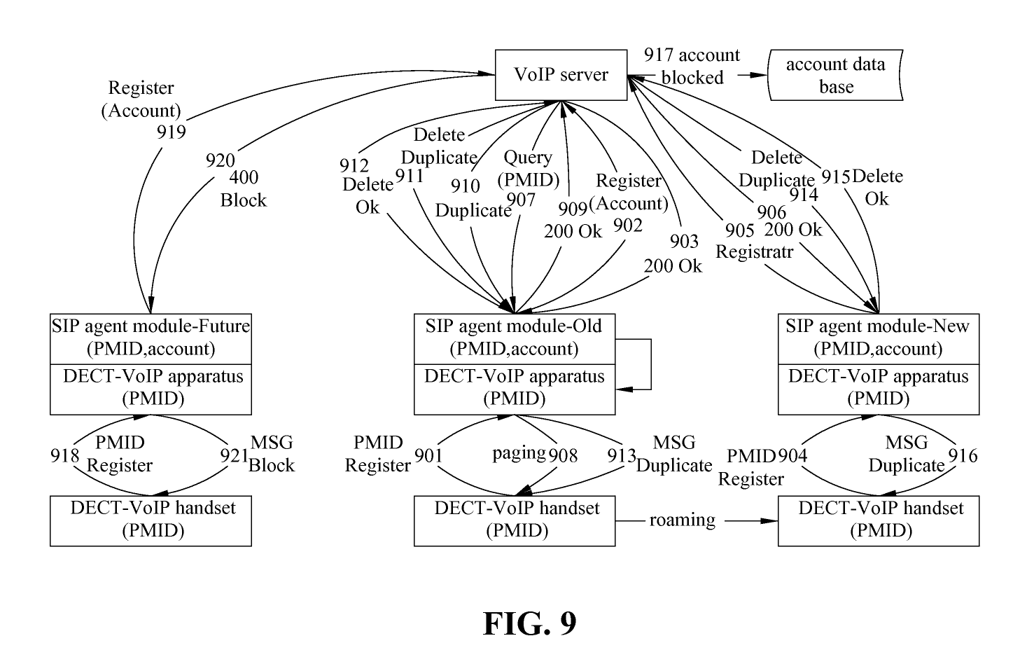

FIG. 8 and FIG. 9 show the schematic views of the signaling during normal roaming and account duplication situation respectively according to the present invention. In FIG. 8, the assumption is that account information via AQA module is already obtained. As shown in FIG. 8, arrows marked as 801, 802 and 803 represent that the initial registration request through the old SIP user agent module is accepted. Then, DECT-VoIP handset roams from the coverage of old DECT-VoIP apparatus to the coverage of new DECT-VoIP apparatus. The DECT-VoIP handset request another registration with PMID as parameter again, marked as 804. The new registration request is again accepted and authenticated by VoIP server via the new DECT-VoIP apparatus, marked as 805 and 806. The VoIP server sends a query with PMID as parameter to the old DECT-VoIP apparatus to confirm the presence/absence of the DECT-VoIP handset and the old DECT-VoIP apparatus pages the DECT-VoIP handset for confirmation. As the DECT-VoIP handset has roamed to the new location and left the coverage of old DECT-VoIP apparatus, the result of the paging shows that the PMID no longer exists at the old DECT-VoIP apparatus, marked as 809. Finally, VoIP server deletes account from the old DECT-VoIP apparatus to complete the normal roaming, marked as 810.

FIG. 9 shows a schematic view of signaling during an account duplicate situation according to the present invention. As shown in FIG. 9, arrows 901, 902 and 903 represent the initial registration of the DECT-VoIP handset with the old DECT-VoIP apparatus, and arrows 904, 905 and 906 represent the registration of the DECT-VoIP handset with the new DECT-VoIP apparatus. Then, VoIP server sends a PMID query to the old DECT-VoIP apparatus (marked as 907) and the old DECT-VoIP apparatus responds to SIP Server with Ok message as an acknowledgement of this Page request (marked as 909). The old DECT-VoIP apparatus pages the DECT-VoIP handset (marked as 908). As the DECT-VoIP handset is still within the coverage of old DECT-VoIP apparatus. VoIP server determines that an account duplicate has occurred (marked as 910). Then, VoIP server must notify the old DECT-VoIP apparatus to delete the duplicated account (marked as 911). The old DECT-VoIP apparatus notifies VoIP server of the account deletion (marked 912) being executed and displays a message on DECT-VoIP handset to inform the account duplicate situation, marked as 913. The same duplication deletion signals are also perform for the new DECT-VoIP apparatus, marked as 914, 915 and 916 respectively. Finally, VoIP server signals the account database to block the duplicate account from future registration, marked as 917. For any future registration of the DECT-VoIP handset with the same ID to any other DECT-VoIP apparatus, the registration will be blocked, marked as arrows 918, 919, 920 and 921.

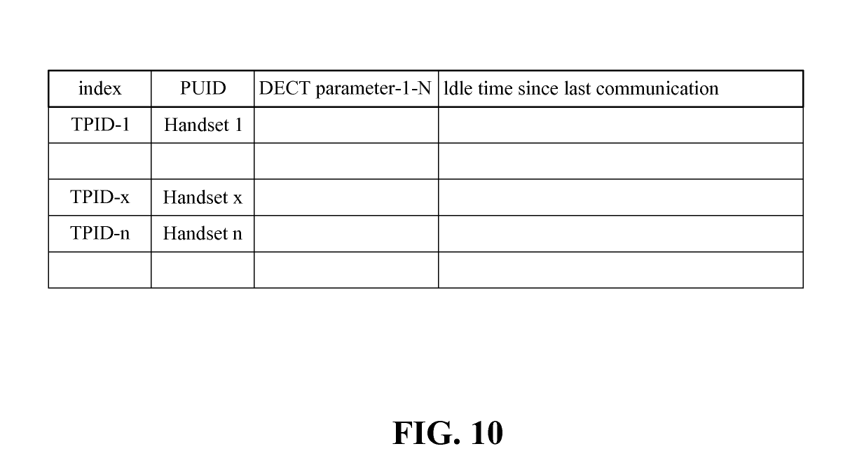

FIG. 10 shows a schematic view of a handset table maintained by the DECT base module of the DECT-VoIP apparatus according to the present invention. When a new DECT-VoIP handset registers on the DECT-VoIP apparatus, the DECT-VoIP apparatus will send the information of TPID and PUID to the SIP user agent module so that the SIP user agent module can query the presence of the DECT-VoIP handset via issuing a command with the TPID as a parameter during the aforementioned background paging confirmation.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A DECT-VoIP system for roaming in DECT-VoIP network, comprising:
a DECT-VoIP handset, being a DECT handset with preset VoIP client account information; and
a DECT-VoIP apparatus, having a DECT base module for interacting with said DECT-VoIP handset, a voice processing module connected to said DECT base module for voice processing, and a session initiation protocol (SIP) user agent (UA) module connected to said voice processing module and acting as an VoIP gateway;
wherein when said DECT-VoIP handset roams from coverage of said DECT-VoIP apparatus to coverage of a second DECT-VoIP apparatus and requesting a new registration with said second DECT-VoIP apparatus to a VoIP server, said VoIP server paging said DECT-VoIP apparatus to determine the presence of said DECT-VoIP handset within said coverage of said DECT-VoIP apparatus, if not present, said VoIP server granting said new registration of said DECT-VoIP handset with said second DECT-VoIP apparatus and deleting previous registration of said DECT-VoIP handset with said DECT-VoIP apparatus; otherwise, said VoIP-DECT server sending message to said DECT-VoIP apparatus and said second DECT-VoIP apparatus to indicate occurrence of an account duplicate situation.

2. The system as claimed in claim 1, wherein said VoIP client account information can be DECT-VoIP handset identification (ID), and said DECT-VoIP handset ID can be mapped find corresponding VoIP client account via an account query agent (AQA) module at said VoIP server.

3. The system as claimed in claim 1, wherein said DECT-VoIP apparatus and said second DECT-VoIP apparatus have the same DECT base identification number (ID) so that a cipher key generated based on said DECT-VoIP handset ID and ID of said DECT-VoIP apparatus can let said DECT-VoIP handset automatically register with said second DECT-VoIP apparatus via ignoring the authentication of cipher key.

4. The system as claimed in claim 1, wherein said VoIP server blocks said account when an account duplicate situation has occurred.

5. The system as claimed in claim 1, wherein said paging to determine presence of said DECT-VoIP handset within coverage of said first DECT-VoIP apparatus is accomplished by checking presence/absence of said DECT-VoIP handset at said first DECT-VoIP apparatus since last communication maintained in a table by said first DECT-VoIP apparatus.

6. An apparatus for allowing a DECT-VoIP handset roaming in DECT-VoIP network, said apparatus comprising:
a DECT base module, for interacting with said DECT-VoIP handset;
a voice processing module, connected to said DECT base module for voice processing or converting a pre-stored VoIP client account entered by said user via a touch tone keypad of said VoIP-DECT handset; and
a session initiation protocol (SIP) user agent (UA) module connected to said voice processing module for acting as an VoIP gateway to connect to Internet.

7. A method for a roaming in DECT-VoIP network, said DECT-VoIP network having a DECT-VoIP handset, a first DECT-VoIP apparatus, a second DECT-VoIP apparatus and an VoIP server, said method comprising the steps of:
said DECT-VoIP handset registering to said first DECT-VoIP apparatus;
said DECT-VoIP handset roaming to coverage of said second DECT-VoIP apparatus and requesting a new registration;
said VoIP server paging said first DECT-VoIP apparatus to check the presence of said DECT-VoIP handset in coverage of said first DECT-VoIP apparatus to determine whether an account duplication situation having occurred;
if said account duplication situation having not occurred, said VoIP server accepting new registration of said DECT-VoIP handset with said second DECT-VoIP apparatus and de-registering said DECT-VoIP handset from said first DECT-VoIP apparatus; and
if account duplication situation having occurred, said VoIP server notifying said first DECT-VoIP apparatus and said second DECT-VoIP apparatus of said account duplicate situation, and displaying a message on said DECT-VoIP handset.

8. The method as claimed in claim 7, wherein said DECT-VoIP handset has a unique handset ID, and said first DECT-VoIP apparatus and said second DECT-VoIP have the same base ID, a cipher key can be self-generated by a program on said DECT-VoIP handset using known parameters.

9. The method as claimed in claim 8, wherein said known parameters comprise said DECT-VoIP handset's unique handset ID, a pre-defined number emulating random number generation defined by DECT GAP protocol, and said same DECT base's ID, or any combination of the above to comply with said DECT GAP protocol.

10. The method as claimed in claim 9, wherein said DECT-VoIP handset automatically registers with said DECT-VoIP apparatus having said same DECT base ID as long as radio coverage exists.

11. The method as claimed in claim 9, wherein said DECT-VoIP apparatus ignores key authentication defined by said GAP protocol and allow temporary registration of said DECT-VoIP handset.

12. The method as claimed in claim 11, wherein authentication will be executed at VoIP account stage instead of via said cipher key defined by said DECT GAP protocol, and said DECT-VoIP apparatus will grant registration of said DECT-VoIP handset when VoIP account of said DECT-VoIP handset is authenticated; otherwise, said DECT-VoIP handset's temporary registration at said DECT-VoIP apparatus will be deleted.

13. The method as claimed in claim 7, wherein said step of said DECT-VoIP handset registering to said first DECT-VoIP apparatus further comprises steps of:
said DECT-VoIP handset requesting registration to said first DECT-VoIP apparatus with own handset ID;
said first DECT-VoIP apparatus forwarding said handset ID to an account query agent (AQA) module of said VoIP server;
said AQA module forwarding said handset ID to VoIP user account database;
said VoIP user account database replying account information corresponding to said handset ID to said AQA module;
said AQA module forwarding said account information to said first DECT-VoIP apparatus;
said first DECT-VoIP apparatus requesting account registration to said VoIP server;
said VoIP server authenticating said account information with said VoIP user account database;
said VoIP account database replying with accepting or rejecting said account registration request;
said VoIP server replying to said first DECT-VoIP apparatus with registration OK or fail; and
said first DECT-VoIP displaying message of connection or disconnection on said DECT-VoIP handset.

14. The method as claimed in claim 7, wherein said step of said VoIP server notifying said first DECT-VoIP apparatus and said second DECT-VoIP apparatus of said account duplicate situation, and displaying a message on said DECT-VoIP handset further comprises the steps of:
deleting duplicate account registration of said DECT-VoIP handset with said first DECT-VoIP apparatus;
deleting duplicate account registration of said DECT-VoIP handset with said second DECT-VoIP apparatus; and
said VoIP server blocking said account on said VoIP account database for further registration request.

15. The method as claimed in claim 7, wherein said paging to determine presence of said DECT-VoIP handset within coverage of said first DECT-VoIP apparatus is accomplished by checking presence/absence of said DECT-VoIP handset at said first DECT-VoIP apparatus since last communication maintained in a table by said first DECT-VoIP apparatus.
